(19) United States
(12) Patent Application Publication
(10) Pub. No.: US 2022/0232921 A1
(43) Pub. Date: Jul. 28, 2022

(54) INTERCHANGEABLE PATCH BASEBALL CAP

(71) Applicant: Michael Teed, SR., rainier, OR (US)

(72) Inventor: Michael Teed, SR., rainier, OR (US)

(21) Appl. No.: 17/157,366

(22) Filed: Jan. 25, 2021

(51) Int. Cl. A42B 1/004; A42B 1/248

(52) U.S. Cl. CPC A42B 1/004; A42B 1/248

(57) ABSTRACT

The interchangeable patch baseball cap is a baseball hat that gives the wearer the ability to swap out the front patch for another patch. Each patch can depict a company or sport logo, a slogan, or some other symbol of the like. Each patch is required to have a loop backing to connect to the baseball cap by hook-and-loop. The baseball cap is designed to be comfortable and utilitarian. The material of the cap body is breathable and somewhat stretchable to accommodate different shapes and sizes of heads. The bill of the hat is stiff to block the sun from the wearer's eyes.

### BACKGROUND

A baseball cap is a type of soft cap with a rounded crown and a stiff bill projecting in front. The front of the cap typically displays a design or a logo (historically, usually only a sports team, namely a baseball team, or names of relevant companies, when used as a commercial marketing technique). The cap may be “fitted” to the wearer's head or the back may have elastic, a plastic prong-in-a-hole (multiple holes with one prong that can be inserted), hook-and-loop, a zipper, or a tri-glide slide so that it can be quickly adjusted to fit different wearers' heads. Since the 1980s, varieties of the hat have become prevalent in the United States and many other nations, both for utilitarian (protecting the eyes from the sun) and fashion accessory purposes. There have been no products available as original equipment or as an aftermarket to address this problem.

There are a variety of different reasons for a baseball cap to be worn. Traditionally, each individual need would necessitate its own baseball cap for use, for example, where each company has a baseball cap for identifying members of that group. This could lead to one person having several baseball caps for each of the purposes that they use, and requires them to keep track of all of their hats for each event. There have been no products available as original equipment or as an aftermarket to address this problem either.

There exists a need for an interchangeable patch baseball cap that is not being met by any known or disclosed device or system of present.

### SUMMARY OF THE INVENTION

The interchangeable patch baseball cap is a baseball hat that gives the wearer the ability to swap out the front patch for another patch. Each patch can depict a company or sport logo, a slogan, or some other symbol of the like. Each patch is required to have a loop backing to connect to the baseball cap by hook-and-loop. The baseball cap is designed to be comfortable and utilitarian. The material of the cap body is breathable and somewhat stretchable to accommodate different shapes and sizes of heads. The bill of the hat is stiff to block the sun from the wearer's eyes.

### BRIEF DESCRIPTION OF THE DRAWINGS

FIG. 1 is a frontal view of the baseball cap with several possible patches that can be placed on the front of the cap, one at a time, in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term [term] is used to refer to [describe, rest of sentence]. The term [term] refers to [describe, rest of sentence].

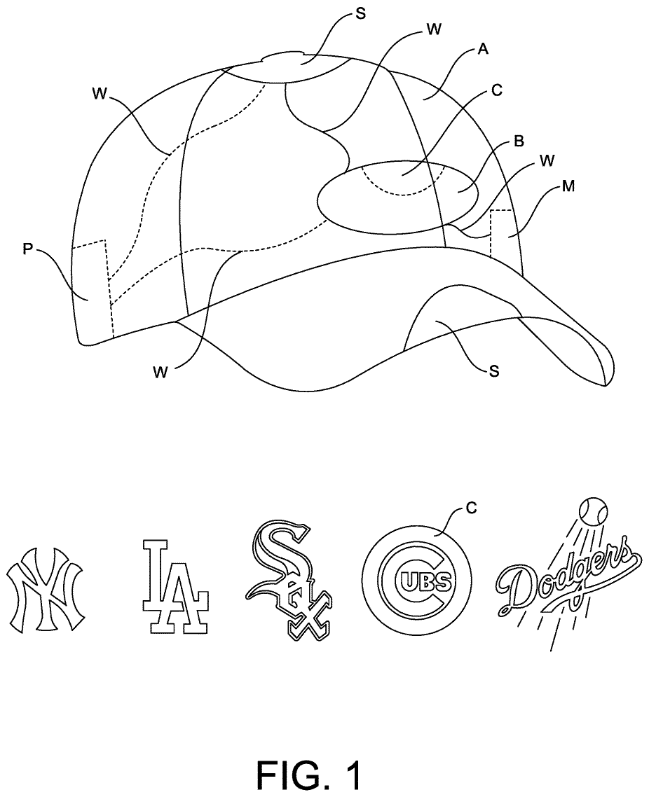

FIG. 1 is a frontal view of the baseball cap with several possible patches that can be placed on the front of the cap, one at a time, in accordance with an embodiment of the present disclosure. On the front of the baseball cap A, there is a portion of the hat with hooks B. The user may place one of many different possible patches on the hat at a time, where each patch C may display a company logo, slogan, other symbol, or the like. Each patch has loop backings as to attach to the hooks from the hat itself.

FIG. 1 further includes at least one solar cell S locateable on any portion or part of the hat, a power source P such as a direct current battery, an electronic memory M with a wireless interface for a user's input storeable thereon, a control circuit CC in communication with the interchangeable and electronic display B, and wires W connecting the parts and portions of the hat as explained and detailed herein. The interchangeable display includes cloth sports team logos, holographic displays of multiple logos from different viewing angles and electronic displays of varying electronic content from electronic memory and multiple hardwired electronic displays. The electronic components described above are also integrated into a single module or circuit in embodiments of the present disclosure.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A hat comprising:
a material comprising a front and sides;
a display portion on the hat, the display portion comprising an area for a display; and
an interchangeable display disposed on the display portion of the hat and configured to be interchangeable via an action of a user of the hat.

2. The hat of claim 1, wherein the material further comprises a top and a back.

3. The hat of claim 1, wherein the display portion of the hat comprises one of a hook and a loop material.

4. The hat of claim 1, wherein the display portion of the hat comprises one of a magnetic material and a metal.

5. The hat of claim 1, wherein the interchangeable display comprises a sports team logo patch with one of a hook and a loop material backing.

6. The hat of claim 1, wherein the interchangeable display comprises a holographic display of at least two different sports team logos viewed from different angles.

7. The hat of claim 1, wherein the interchangeable display comprises an electronic display programmable by the user of the hat.

8. The hat of claim 1, further comprising a power source in communication with an electronic interchangeable display attached to the display portion of the hat.

9. The hat of claim 1, further comprising a control circuit in communication with an electronic interchangeable display attached to the display portion of the hat, the control circuit controllable by the user of the hat.

10. The hat of claim 1, further comprising a solar cell for generating electricity deliverable to an electronic interchangeable display attached to the display portion of the hat.

11. The hat of claim 1, further comprising a direct current battery for electricity deliverable to an electronic interchangeable display attached to the display portion of the hat.

12. A hat comprising:
an interchangeable electronic display disposed on the hat and configured to be interchangeable via an action of a user of the hat;
an electronic control circuit configured to control the interchangeable electronic display on the hat according to an input from the user of the hat;
an electronic memory configured to store interchangeable displays for the interchangeable electronic display on the hat per the user input; and
a solar cell in communication with the electronic control circuit and the interchangeable electronic display.

13. The hat of claim 12, further comprising one of a hook and a loop material on the hat configured to locate the solar cell via a complementary hook and loop backing to any location on the hat.

14. The hat of claim 12, further comprising one of a hook and a loop material on the hat configured to locate the interchangeable electronic display via a complementary hook and loop backing to any location on the hat.

15. The hat of claim 12, further comprising a wireless interface with the electronic control circuit for a remote control of the interchangeable electronic display.

16. The hat of claim 12, further comprising a direct current battery backup to the solar cell.

17. The hat of claim 12, further comprising a wireless interface with the electronic memory for a user to download images storeable therein.

18. The hat of claim 12, wherein the interchangeable electronic display comprises a plurality of electronic displays, each hardwired to display a predetermined sports team logo.

19. The hat of claim 12, wherein the interchangeable electronic display comprises programmable pixels configured to display an image predetermined by the user of the hat.

20. The hat of claim 12, wherein the interchangeable display comprises a holographic display of at least two sports team logos based on a viewing angle thereof.
